(19) United States
(12) Patent Application Publication
(10) Pub. No.: US 2007/0063601 A1
(43) Pub. Date: Mar. 22, 2007

(54) Vibration motor

(75) Inventors: Eiichi Ibata, Gyeonggi-do (KR); Hyun Gi Yang, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon-si (KR)

(21) Appl. No.: 11/518,424

(22) Filed: Sep. 11, 2006

(30) Foreign Application Priority Data
Sep. 16, 2005 (KR) 10-2005-0087044

(51) Int. Cl. H02K 7/06; H02K 7/10

(52) U.S. Cl. 310/81

(57) ABSTRACT

A vibration motor 100 of the present invention comprises a housing 100 having an outer housing 111 and an inner housing 115 being inwardly extended from the outer housing 111, a magnet 130 being formed longer than the inner housing 115 and being fixedly combined to an outer periphery surface of the inner housing 115, and an opposite output bearing 140 for rotatably supporting a rotating shaft 150 and being combined to the magnet 130 to be closely contacted with the inner periphery surface of the magnet 130. The bearing 140 is disposed on the end of the inner housing 115 in contact and has a plurality of recesses 142 axially formed on the outer periphery surface thereof.

### BACKGROUND OF THE INVENTION

1. Field of the Invention

The present invention relates to a vibration motor, more particularly, to a vibration motor with small size, superior characteristics and high durability with increasing thickness of the magnetic.

2. Description of the Related Art

In general, vibration motors are used to notify the users of the reception of a communication through their vibration, the motor being installed in a mobile communication device, such as mobile phones, and one of examples thereof is illustrated in FIG. 9.

As shown in FIG. 9, a conventional motor 400 is composed of a housing 410, an output bearing 420, an opposite output bearing 430, a rotating shaft 440, a magnet 450, a coil 460, and an eccentric pendulum 470.

The housing 410 is comprised of an outer housing 411 being an outer case of the motor 400, and an inner housing 415 formed to be inwardly integrally extended from the outer housing 411.

The output bearing 420 is forcibly inserted into and combined to the inlet portion of the housing 410, and the opposite output bearing 430 is forcibly inserted into and combined to the end of the inner housing 415 opposite to the output bearing 420.

The rotating shaft 440 is installed in the inner housing 415 so as to pass through both the output bearing 420 and the opposite output bearing 430 and to be rotatably supported by the bearings 420 and 430.

The magnet 450 is attached on the outer periphery surface of the inner housing 415, and the coil 460 is attached on the inner periphery surface of the outer housing 411 opposed to the magnet 450.

The eccentric pendulum 470 is eccentrically combined with the rotating shaft 440 exposed out of the housing 410.

However, the conventional motor 400, considering the requirement of its small size, should have thin magnet 450 so as to attach the magnet 450 on the outer periphery surface of the inner housing 415 in limited space since the opposite output bearing 430 is inwardly inserted into and combined to the inner housing 415. This causes a drawback of deterioration of the characteristics of the motor and the damage or breakage to the magnet due to the faulty drop of mobile communication devices.

### SUMMARY OF THE INVENTION

Accordingly, the present invention is directed to a vibration motor that substantially obviates one or more problems due to limitations and disadvantages of the prior art.

An object of the present invention is to provide a vibration motor having small size, superior characteristics and high durability by directly combining the opposite output bearing with not an inner housing but the inner periphery surface of the magnet, whereby increasing the thickness of the magnet in limited space

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a vibration motor comprises: a housing having an outer housing and an inner housing being inwardly extended from the outer housing; a magnet being formed longer than the inner housing and being fixedly combined with the outer periphery surface of the inner housing; and a bearing for rotatably supporting a rotating shaft, the bearing being combined with the magnet to be closely contacted with the inner periphery surface of the magnet

The bearing may be disposed on the end of the inner housing in contact, and may have a plurality of recesses or a plurality of protrusions axially formed on the outer periphery surface thereof.

Alternately, the bearing may have a cylindrical body being combined with an inner periphery surface of the magnet and a disk-like body being combined with the end of the magnet, and the cylindrical body may have a plurality of recesses or a plurality of protrusions axially formed on the outer periphery surface thereof.

Further, alternately, the bearing may have a cylindrical body and an annular extension being outwardly extended in radial direction from the body, and the extension may elastically support the magnet in radial direction.

Wherein, the extension may be disposed to be contacted with the end of the inner housing, and have a plurality of recesses or a plurality of protrusions axially formed on the outer periphery surface thereof.

### BRIEF DESCRIPTION OF THE DRAWINGS

The accompanying drawings, which are included to provide a further understanding of the invention are incorporated and constitute as a part of this application, illustrate embodiment(s) of the invention and together with the descriptions serve to explain the principle of the invention. In the drawings:

FIG. 1 is a cross-sectional view schematically illustrating a vibration motor according to one preferred embodiment of the present invention;

FIG. 2 is a view schematically showing a bearing installed in the vibration motor of FIG. 1;

FIG. 3 is a view schematically illustrating a modification of the bearing of FIG. 2;

FIG. 4 is a cross-sectional view schematically illustrating a vibration motor according to another preferred embodiment of the present invention;

FIG. 5 is a view schematically illustrating a bearing installed in the vibration motor of FIG. 4;

FIG. 6 is a cross-sectional view schematically illustrating a vibration motor according to a further another preferred embodiment of the present invention;

FIG. 7 is a view schematically illustrating a bearing installed in the vibration motor of FIG. 6;

FIG. 8 is a view schematically illustrating a modification of the bearing of FIG. 7; and

FIG. 9 is a cross-sectional view schematically illustrating a conventional vibration motor.

### DETAILED DESCRIPTION OF THE INVENTION

Reference will now be made in detail to the preferred embodiments of the present invention, examples of which are illustrated in the accompanying drawings.

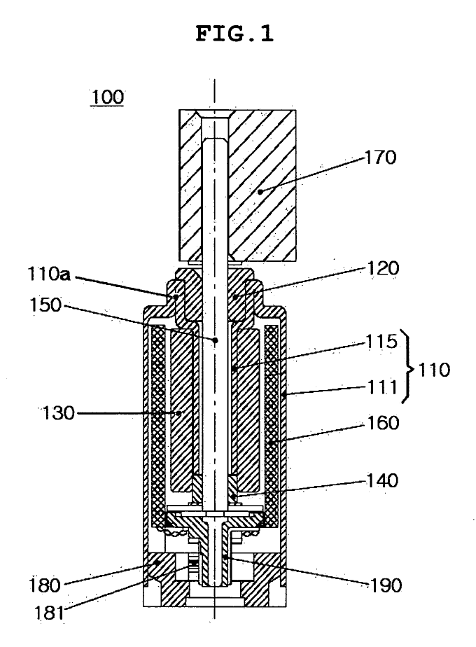

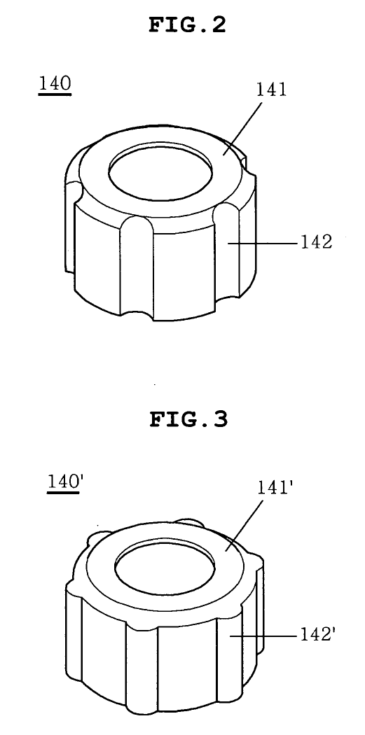

Referring to FIGS. 1 and 2, a vibration motor 100 according to one preferred embodiment of the present invention will be explained in detail.

As shown, the vibration motor 100 comprises a housing 110, an output bearing 120, a magnet 130, an opposite output bearing 140, a rotating shaft 150, a coil 160, and an eccentric pendulum 170.

The housing 110 receives all above elements, and it has an outer housing 111 and an inner housing 115.

The outer housing 111 serves to an outer case of the motor 100, and it is formed to have a hollow cylinder type.

The inner housing 115 is inwardly integrally extended from the outer housing 111 so as to be shorter than the outer housing 111. Also, a bending portion connecting the outer housing 111 and the inner housing 115 serves to an inlet portion 110a of the housing 110.

The output bearing 120 is inserted into the inlet portion 110a of the housing 110 in closely contact so as to have at least a portion exposed outwardly.

The magnet 130, a hollow cylindrical, is fixedly combined with an outer periphery surface of the inner housing 115 so as to be longer than the inner housing 115.

The opposite output bearing 140 is combined with the magnet 130, more particularly, with an inner periphery surface of the magnet 130 in closely contact, and the bearing 140 has one end contacted with the end of the inner housing l l and the other end portion exposed outwardly.

Wherein, the opposite output bearing 140 has a hollow cylindrical body 141, and the body 141 has a plurality of recesses 142 formed on the outer periphery surface thereof with a predetermined distance axially.

In the present embodiment, the opposite output bearing 140, as shown in FIG. 2, has the cylindrical body 141 formed with a plurality of recesses 142 on the outer periphery surface thereof, however, alternately, as shown in FIG. 3, it may have cylindrical body 141′ formed with a plurality of protrusions 142′ on the outer periphery surface thereof with a predetermined distance axially.

Like this, in either case of forming a plurality of recesses 141 or forming a plurality of protrusions 142′, the bearing 140 may have an increased contact area between the magnet 130 in which the size or surface of an inside diameter is not uniform, and therefore the bearing 140 can be strongly combined with the magnet 130.

The rotating shaft 150 is installed in the inner housing 115 without contact so as to pass through the output bearing 120 and the opposite output bearing 140 and be rotatably supported by them. Wherein, the shaft 150 is outwardly exposed at least a portion thereof and supported by the bearings 120 and 140, thereby a narrow gap being defined by the shaft 150 and the inner housing 115 therebetween.

The coil 160 is combined with the housing 110, more particularly with an inner periphery surface of the outer housing 111 to be opposed to the magnet 130 with a predetermined distance, and it is formed to be longer than the magnet 130.

The eccentric pendulum 170 is eccentrically combined with a portion of the shaft 150 exposed outwardly from the housing 110.

A base 180 is fixedly combined with an opening of the housing 110, and a brush 181 is installed on the base 180.

A commutator 190 is installed in a side end portion of the opposite output bearing 140, wherein, the commutator 190 is disposed on the inner periphery of the coil 160.

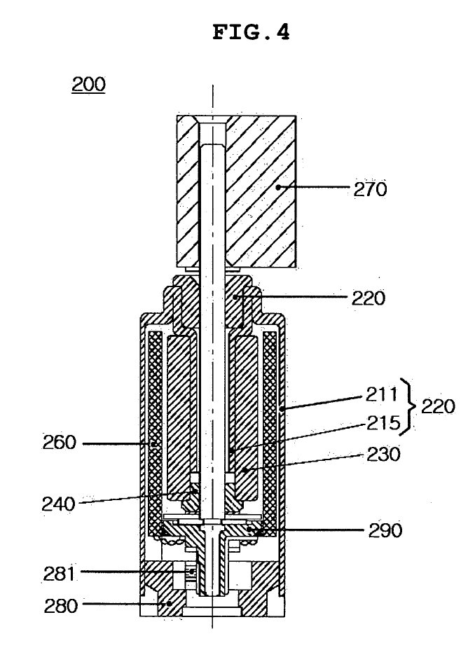

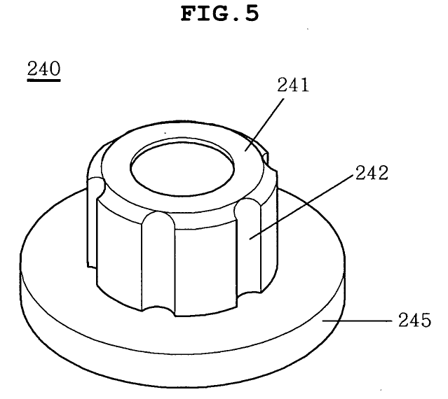

Next, a vibration motor 200 according to another embodiment of this present invention will be explained in detail, referring to FIGS. 4 and 5.

As shown, a vibration motor 200 comprises a housing 210, an output bearing 220, a magnet 230, a rotating shaft 250, a coil 260, an eccentric pendulum 270, a base 280, a brush 281, and a commutator 290. Hereinafter, the explanation will be accomplished for only different elements from the above embodiment, and the same elements which already described above through FIGS. 1 and 2, will not explained.

The opposite output bearing 240 is combined with the magnet 230, more particularly with an inner periphery surface of the magnet 230 to be closely contacted thereto, wherein one end of the bearing 240 is apart from an end of inner housing 215 with a predetermined distance and the other end thereof is outwardly extended to support an end of the magnet 230.

Wherein, the opposite output bearing 240 has a hollow cylindrical body 241 and a disk-like body 245. The body 241 has a plurality of recesses 242 axially formed on the outer periphery surface thereof with a predetermined distance, and the body 245 is outwardly extended from the body 241 in radial direction.

In this embodiment, the opposite output bearing 240 is formed to have a plurality of recesses 242 formed on the outer periphery surface of the body 241 thereof, alternately, as not shown in figures, a plurality of protrusions, such as protrusions of FIG. 3, instead of recesses may be axially formed on the outer periphery surface of the body 241 with a predetermined distance.

Like this, in either case of forming a plurality of recesses 242 or forming a plurality of protrusions on the outer periphery surface of the body 241, the bearing 240 can have an increased contact area between the magnet 230 of which an inner surface is not uniform. The contacting area between the magnet 230 and the bearing 240 may be greatly increased by supporting in closely contact the magnet 230 with the disk-like body 245 support. This enables the bearing 240 to strongly combine with the magnet 230.

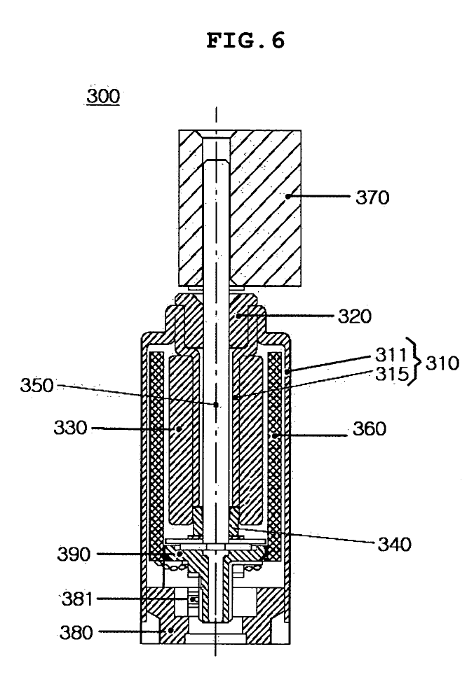

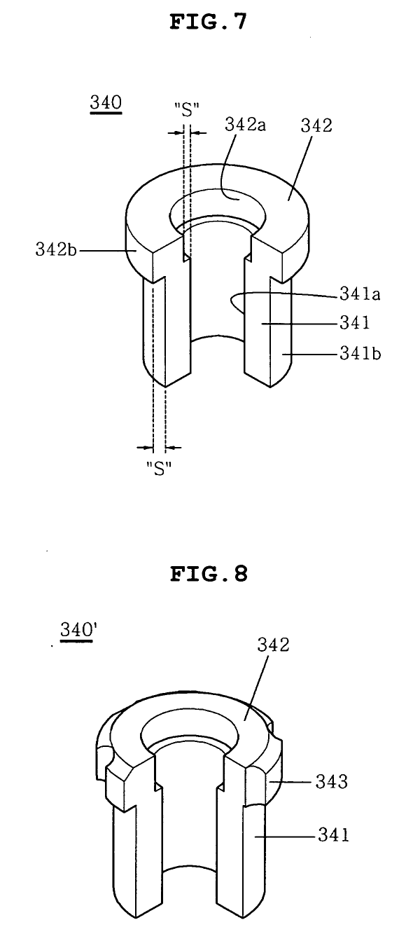

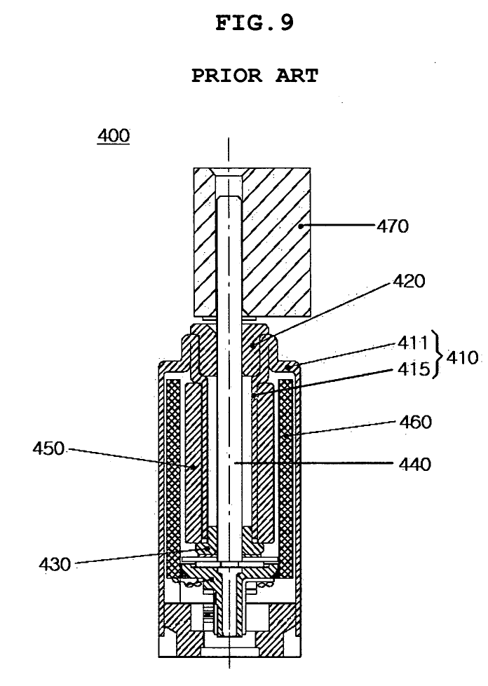

Next, a vibration motor 300 according to further another embodiment of the present invention will be explained in detail, referring to FIGS. 6 and 7.

As shown, a vibration motor 300 comprises a housing 310, an output bearing 320, a magnet 330, a rotating shaft 350, a coil 360, an eccentric pendulum 370, a base 380, a brush 381, and a commutator 390. Hereinafter, the explanation will be accomplished for only different elements from the above embodiment, and the same elements which already described above through FIGS. 1 and 2, will not explained.

The opposite output bearing 340 is combined with the magnet 330, more particularly with an inner periphery surface of the magnet 330 to be closely contacted thereto, wherein one end of the bearing 340 is contacted with an end of inner housing 315 and the other end thereof is outwardly exposed from the magnet 330.

Wherein, the opposite output bearing 340 has a hollow cylindrical body 341 and an annular extension 342 being outwardly extended from the upper portion of the body 341 in radial direction. At this time, the extension 342 is slightly stepped from the body 341, whereby a predetermined space “S” being formed between the inner periphery surface 341a of the body 341 and the inner periphery surface 342a of the extension 342 and between the outer periphery surface 341b of the body 341 and the outer periphery surface 342b of the extension 342.

Therefore, when the opposite output bearing 340 is combined with the inner periphery surface of the magnet 330, the extension 342 is closely contacted with the magnet 330, at this time the extension 342 is inwardly compressed as much as the space “S” in maximum and elastically supports the magnet 330 in radial direction, the space “S” being formed between the inner periphery surface 341a of the body 341 and the inner periphery surface 342a of the extension 342.

In this embodiment, the opposite output bearing 340 is formed to have smooth outer periphery surface of the extension 342 thereof, alternately, as shown in FIG. 8, the opposite bearing 340′ may be formed to have a plurality recesses 343 axially formed on the outer periphery surface of the extension 342′, with constant distance, extended from the body 341′.

According to the vibration motor of the present invention, since the opposite output bearing is directly combined with not the inner housing but the inner periphery surface of the magnet, it enables to greatly increase the thickness of the magnet within the limited space, and thereby, a motor, even small in size, may have greatly increased characteristics and durability.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A vibration motor, the motor comprising:
a housing having an outer housing and an inner housing being inwardly extended from the outer housing;
a magnet being formed longer than the inner housing and being fixedly combined to an outer periphery surface of the inner housing; and
a bearing for rotatably supporting a rotating shaft, the bearing being combined to the magnet to be closely contacted with the inner periphery surface of the magnet.

2. The motor according to claim 1, wherein the bearing is disposed on the end of the inner housing in contact and has a plurality of recesses or a plurality of protrusions axially formed on the outer periphery surface thereof.

3. The motor according to claim 1, wherein the bearing has a cylindrical body being combined with an inner periphery surface of the magnet and a disk-like body being combined with an end of the magnet, the cylindrical body having a plurality of recesses or a plurality of protrusions axially formed on the outer periphery surface thereof.

4. The motor according to claim 1, wherein the bearing has a cylindrical body and an annular extension being outwardly extended from the cylindrical body in radial direction, the extension elastically supporting the magnet in radial direction.

5. The motor according to claim 4, wherein the extension has a plurality of recesses or a plurality of protrusions axially formed on the outer periphery surface thereof.

6. The motor according to claim 4, wherein the extension is disposed to be contacted with an end of the inner housing.

7. The motor according to claim 6, wherein the extension has a plurality of recesses or a plurality of protrusions axially formed on the outer periphery surface thereof.
